(19) United States
(12) Patent Application Publication
(10) Pub. No.: US 2025/0067640 A1
(43) Pub. Date: Feb. 27, 2025

(54) VESSEL UNIT FOR MOUNTING MEDIUM AND ARRANGEMENT WITH COVERSLIPPER AND VESSEL UNIT

(71) Applicants: Leica Biosystems Nussloch GmbH, Nussloch (DE); Leica Biosystems Richmond, Inc., Richmond, IL (US)

(72) Inventors: Joscha GOTTWALD, Ladenburg (DE); Roman ZHURAVLEV, Northbrook, IL (US)

(21) Appl. No.: 18/237,923

(22) Filed: Aug. 25, 2023

(51) Int. Cl. G01N 1/31; B65D 41/04; B65D 43/00; B65D 47/06; B65D 51/18; B65D 53/02; G01N 1/30

(52) U.S. Cl. CPC G01N 1/312; B65D 41/04; B65D 43/00; B65D 47/06; B65D 51/18; B65D 53/02; G01N 1/30; B65D 2251/0078; B65D 2251/0081; B65D 2251/205

(57) ABSTRACT

The disclosure relates to a vessel unit (2000) comprising a vessel (2200), a vessel connection part (2100) and a vessel closure (2300), the vessel connection part (2100) being connected to the vessel (2200) by the vessel closure (2300), the vessel connection part (2100) comprising a vessel connection part body (2130), a vessel pressure medium channel (2120) for pressure medium and a vessel pressure medium channel (2110) for pressure medium, a vessel mounting medium channel (2110) for the mounting medium, and a vessel pressure medium channel (2120) for a pressure medium, wherein the vessel unit (2000) is adapted to dispense mounting medium via the vessel mounting medium channel (2110) when pressure medium is supplied via the vessel pressure medium channel (2120). The disclosure further relates to an assembly comprising the vessel unit and an automatic coverslipper for automatically applying the coverslipping medium from the vessel unit and a coverslip to a slide.

The present disclosure relates to a vessel unit for mounting medium and an assembly comprising the vessel unit and an automatic coverslipper for automatically applying the mounting medium from the vessel unit and a coverslip to a slide.

### BACKGROUND

For pathological examinations, stained specimens or tissue samples, like a histological section, are fixed on slides and covered with a coverslip. The specimens covered in this way can then be examined under a microscope. For the application of the coverslip to the microscopic slide, the use of automatic coverslippers is particularly suitable, in which the application of the coverslip or the covering of the individual slides is carried out in an automated process. For this process, several slides with tissue samples are sorted into compartments or slots of a rack or slide holder. The rack is fed to the coverslipper, where one slide at a time is removed from the rack and a mounting medium is applied to the slide. The coverslip is then applied to the slide to seal the tissue sample on the slide. The consumables “coverslip” and “mounting medium” must be refilled regularly.

Such an automatic coverslipper is marketed by the applicant under the designation “Leica CV 5030”, for example.

### SUMMARY

According to the disclosure, a vessel unit for mounting medium and an arrangement comprising the vessel unit and an automatic coverslipper for automatically applying the mounting medium from the vessel unit and a coverslip to a slide with the features of the independent patent claims are proposed. Advantageous embodiments are the subject of the dependent claims and the following description.

According to an aspect of the disclosure, a vessel unit is proposed comprising a vessel, a vessel connection part, and a vessel closure, the vessel connection part being connected to the vessel by the vessel closure, the vessel connection part comprising a vessel connection part body, a vessel mounting medium channel for the mounting medium, and a vessel pressure medium channel for a pressure medium, wherein the vessel unit is adapted to dispense mounting medium via the vessel mounting medium channel when pressure medium is supplied via the vessel pressure medium channel.

The disclosure introduces a vessel unit for mounting medium that can be quickly and safely connected to and disconnected from an automatic coverslipper without the risk of mounting medium leaking due to misoperation.

According to another aspect of the disclosure, an arrangement comprising the vessel unit for mounting medium and an automatic coverslipper for automatically applying the mounting medium from the vessel unit and a coverslip to a slide is proposed, wherein the automatic coverslipper comprises a connection part, wherein the machine connection part comprises a machine connection part body, a machine mounting medium channel for the mounting medium and a machine pressure medium channel for the pressure medium. The machine connection part and the vessel connection part are adapted to fluid-tightly connect the machine mounting medium channel and the vessel mounting medium channel on the one hand and the machine pressure medium channel and the vessel pressure medium channel on the other hand, respectively, when the machine connection part and the vessel connection part are connected. The arrangement is adapted to connect the machine connection part and the vessel connection part by moving the machine connection part and the connection part relatively to each other in a first direction, wherein first the machine mounting medium channel and the vessel mounting medium channel are fluid-tightly connected, and subsequently the machine pressure medium channel and the vessel pressure medium channel are fluid-tightly connected, and to disconnect the machine connection part and the vessel connection part from each other, by moving the machine connection part and the connection part relatively to each other in a second direction opposite to the first, wherein first the fluid-tight connection between the machine pressure medium channel and the vessel pressure medium channel is disconnected, and then the fluid-tight connection between the machine mounting medium channel and the vessel mounting medium channel is disconnected.

The disclosure presents a vessel unit for or with mounting medium which can be connected in a simple and safe manner to associated connections of an automatic coverslipper. In particular, the susceptibility to faulty operation is minimized and the cleanliness and purity of the mounting medium is also ensured.

According to at least one embodiment, the vessel mounting medium channel has a mounting medium feedthrough provided in the vessel connection part body with a third sealing surface formed by a mounting medium feedthrough inner wall.

According to at least one embodiment, a socket is arranged on the mounting medium feedthrough, on which a mounting medium hose is arranged. According to at least one embodiment, the mounting medium hose leads to the bottom of the vessel.

According to at least one embodiment, the mounting medium channel is designed to receive a tube, in particular a pipe, wherein the third sealing surface formed by the mounting medium feedthrough inner wall and a first sealing surface formed by a tube outer wall are opposite each other when the tube is received in the mounting medium channel or when the machine connection part and the vessel connection part are connected.

According to at least one embodiment, a mounting medium seal, in particular in the form of an O-ring, is provided between the first and third sealing surfaces.

According to at least one embodiment, the mounting medium seal is arranged on the vessel connection part body in a groove comprising the mounting medium feedthrough inner wall.

According to at least one embodiment, the vessel connection part body is connected to a vessel connection part lid, wherein a groove flank of the groove comprising the mounting medium feedthrough inner wall is formed by the vessel connection part lid.

According to at least one embodiment, the vessel pressure medium channel comprises at least one pressure medium feedthrough provided in the vessel connection member body.

According to at least one embodiment, the vessel connection part body includes a vessel connection part body outer wall, wherein the vessel pressure medium channel includes a fourth sealing surface formed by the vessel connection part body outer wall.

According to at least one embodiment, the vessel connection part body is configured to be received or enclosed by a sleeve having a second sealing surface formed by a sleeve inner wall, the second and fourth sealing surfaces being opposite each other when the vessel connection part body is received or enclosed in the sleeve.

According to at least one embodiment, a pressure medium seal, in particular in the form of an O-ring, is provided between the second and fourth sealing surfaces.

According to at least one embodiment, the pressure medium seal is arranged on the vessel connection part body in a groove comprising the vessel connection part body outer wall.

According to at least one embodiment, the vessel connection part body is connected to a vessel connection part lid, wherein a groove flank of the groove having the vessel connection part body outer wall is formed by the vessel connection part lid.

According to at least one embodiment, the at least one pressure medium feedthrough provided in the vessel connection part body has a further pressure medium seal, in particular in the form of an O-ring, at an interface between the vessel connection part body and the vessel connection part lid.

According to at least one embodiment, the vessel mounting medium channel comprises a mounting medium feedthrough provided in the vessel connection part body, wherein an opening of the mounting medium feedthrough and an opening of the at least one pressure medium feedthrough are arranged concentrically to a central axis of the vessel unit.

According to at least one embodiment, an opening of the vessel mounting medium channel and an opening of the vessel pressure medium channel are arranged concentrically to a central axis of the vessel unit.

According to at least one embodiment, a vessel seal, in particular in the form of an O-ring, is provided between the vessel connection part and the vessel.

According to at least one embodiment, the vessel closure is designed as a screw closure for screwing onto the vessel.

According to at least one embodiment, a vessel cover is disposed on the vessel closure to cover the vessel mounting medium channel and the vessel pressure medium channel.

According to at least one embodiment, the vessel of the vessel unit contains mounting medium, so that slides in the coverslipper can be coverslipped.

According to at least one embodiment, the vessel of the vessel unit contains solvent such as ethanol or xylene, so that the parts of the coverslipper that come into contact with mounting medium can be easily cleaned. Those parts can comprise a hollow needle or nozzle, supply lines, the machine mounting medium channel etc.

Further advantages and embodiments of the disclosure are apparent from the description and the accompanying drawing.

The disclosure is illustrated schematically with reference to embodiments in the drawing and is described below with reference to the drawing.

### BRIEF DESCRIPTION OF THE DRAWINGS

FIG. 1 schematically shows an embodiment of an arrangement with an automatic coverslipper and a vessel unit in a perspective view.

FIG. 2 shows an embodiment of a vessel unit in a cross-sectional view.

FIG. 3 shows the vessel unit from FIG. 2 in an exploded view.

FIG. 4 shows the vessel connection part of the vessel unit from FIG. 2 in a cross-sectional view.

FIG. 5 shows the vessel connection part from FIG. 4 in an exploded view.

FIG. 6 shows a cross-sectional view of a section of a machine connection part and a vessel connection part.

### EMBODIMENT(S)

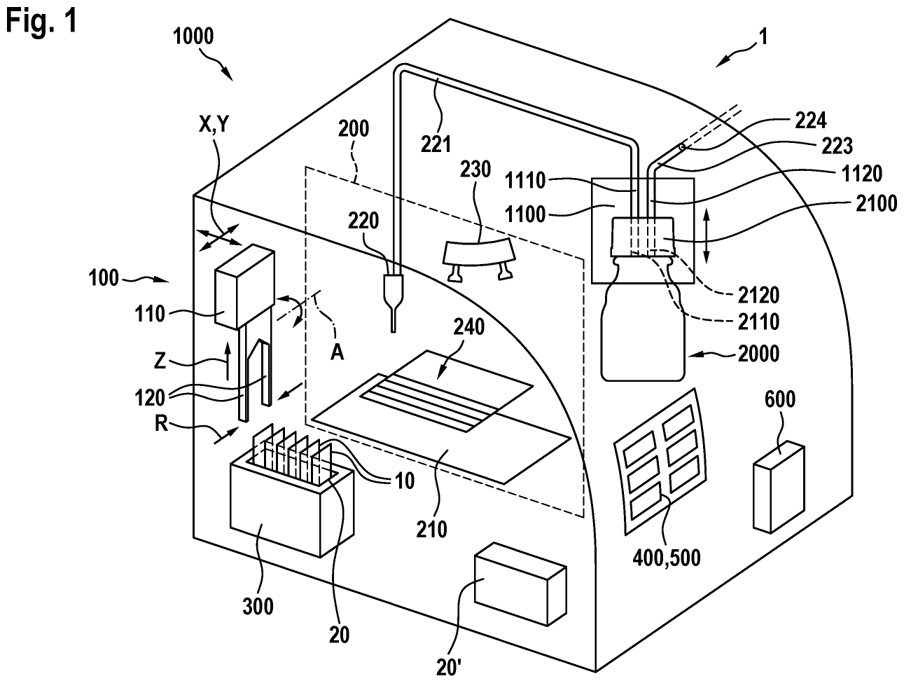

In FIG. 1, an embodiment of an arrangement comprising an automatic coverslipper 1000 and a vessel unit 2000 is shown schematically in a perspective view and is denoted 1 overall. The coverslipper 1000 is arranged for automatically coverslipping slides 10 held in a slide holder 20, and includes a transport mechanism 100 and a coverslipping mechanism 200.

The slide holder 20 with a number of slides 10 is stored in a container 300, which may contain solvent, for example. Suitable slide holders or racks are shown, for example, in US 2012/0138499 A1, which is fully incorporated by reference.

In the example shown, the transport mechanism 100 includes a body 110 and two transport jaws 120 that are reciprocally movable in at least one direction R to transport or grip a slide 10 between the transport jaws 120. The body 110 together with the transport jaws 120 may be movable in a plurality of directions X, Y, and Z within the coverslipper 1000 to move gripped slides 10 to a desired position. In particular, the transport jaws 120 with a slide 10 gripped therein may also be rotatable about an axis of rotation A to pivot a slide 10 disposed vertically in the container 300 into a horizontal position, which is a prerequisite for further processing in the automatic coverslipper 1000.

The coverslipping mechanism 200 includes a receiving location 210 on which a slide 10 may be placed. The receiving location 210 may be configured to fix and/or move a received slide 10 in certain directions. A mounting medium may be applied to a slide 10 received at the receiving location 210 via a hollow needle or nozzle 220. By means of a coverslip picker 230, one of a plurality of coverslips 240 may be picked up, for example by negative pressure, and placed on the coverslip 10 provided with mounting medium.

The coverslipper 1000 according to the embodiment has a vertically movable machine connection part 1100, and the vessel unit 2000 has a vessel connection part 2100, which are adapted to cooperate and are connected in FIG. 1. The machine connection part 1100 includes a machine mounting medium channel 1110 for mounting medium and a machine pressure medium channel 1120 for a pressure medium. Similarly, the vessel connection part 2100 includes a vessel mounting medium channel 2110 for the mounting medium and a vessel pressure medium channel 2120 for the pressure medium. The machine connection part 1100 and the vessel connection part 2100 are configured to fluid-tightly connect, on the one hand, the machine mounting medium channel 1110 and the vessel mounting medium channel 2110 and, on the other hand, the machine pressure medium channel 1120 and the vessel pressure medium channel 2120, respectively, when the machine connection part 1100 and the vessel connection part 2100 are connected.

The nozzle 220 is connected to the machine pressure medium channel 1110 in the machine connection part 1100 via a supply line 221. Further, the machine pressure medium channel 1120 is connected to a pump 224 via a supply line 223. In particular, the pump 224 serves to deliver pressurized medium, such as air, to the vessel unit 2000 via the supply line 223 when the vessel unit 2000 is connected to the automatic coverslipper 1000, thereby forcing mounting medium from the vessel unit 2000 to the nozzle via the supply line 221. With respect to the basic operation of a mounting mechanism, reference is made, for example, to US 2012/0189412 A1, which is fully incorporated by reference.

The coverslipper 1000 is arranged to remove the slides 10 held in the slide holder 20 from the slide holder 20 in sequence by means of the transport mechanism 100 and to feed them to the coverslipping mechanism 200, so that an automatic and ideally uninterrupted coverslipping sequence of coverslipping operations takes place until all the slides 10 held in the slide holder 20 have been provided with a coverslip. For dispensing the coverslipped slides, another slide holder 20′ may be provided into which the coverslipped slides are inserted, for example also by means of the transport mechanism 100.

On a display device such as a display 400, which can also be designed as a touch screen, various information can be displayed during operation and/or inputs can be received from a user in the sense of a man-machine interface 500.

A computing unit, such as a control unit 600, may be provided for controlling the aforementioned components of the automatic coverslipper 1000, which is programmatically configured to control the automatic coverslipper 1000.

The arrangement 1 is adapted to connect the machine connection part 1100 and the vessel connection part 2100 by moving the machine connection part and the connection part relatively to each other in a first direction, in the shown embodiment by vertically moving the machine connection part 1100 in a first vertical direction, which is downward in the figures. In this process, the machine mounting medium channel 1110 and the vessel mounting medium channel 2110 are first connected in a fluid-tight manner, and then the machine pressure medium channel 1120 and the vessel pressure medium channel 2120 are additionally connected in a fluid-tight manner.

By moving the machine connection part and the connection part relatively to each other in a second direction opposite to the first, in the shown embodiment by moving the machine connection part 1100 vertically in a second vertical direction, which is upward in the figures, the machine connection part 1100 and the vessel connection part 2100 are again disconnected from each other, the steps being reversed, i.e., first the fluid-tight connection between the machine pressure medium channel 1120 and the vessel pressure medium channel 2120 is disconnected, and then the fluid-tight connection between the machine mounting medium channel 1110 and the vessel mounting medium channel 2110 is disconnected.

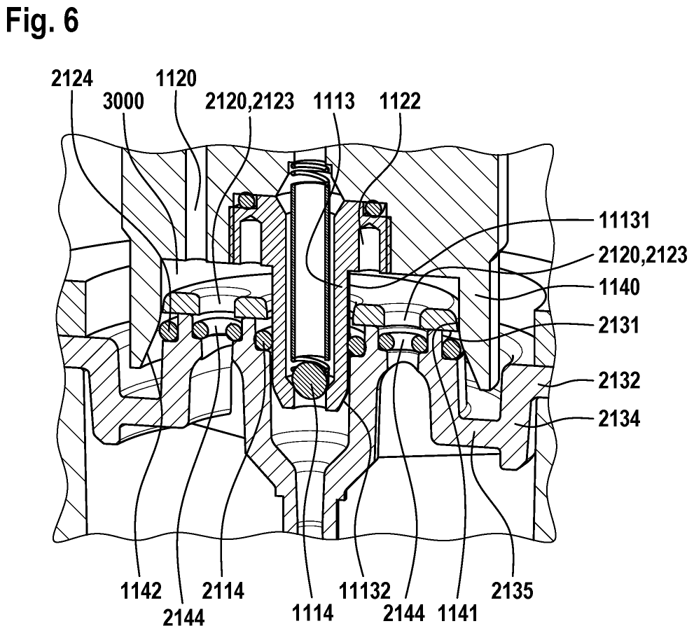

As shown in FIG. 6, the machine connection part 1100 includes a machine connection part body 1130 formed of metal, for example. The machine mounting medium channel 1110 includes a mounting medium bore 1112 in the machine connection part body 1130, and a vertically extending tube 1113 extending from the machine connection part body 1130 with a first sealing surface formed by an outer tube wall 11131.

The machine mounting medium channel 1110 further comprises here a valve 1114, which closes the machine mounting medium channel 1110 when it is not fluid-tightly connected to the vessel mounting medium channel 2110. Presently, the valve 1114 is configured as a check valve having a spring-loaded ball. Advantageously, the valve 1114 prevents mounting medium from drying within the machine mounting medium channel 1110 when no vessel unit 2000 is connected. To prevent heavy buildup of mounting medium, the valve 1114 and/or the tube 1113 and/or surfaces of the machine connection member body 1130 facing the vessel unit connection member 2100 may be provided with a non-stick coating.

Furthermore, a sleeve 1140 surrounding the tube 1113 at a distance D, in particular in the form of a cylinder wall, is arranged on the machine connection part body 1130, in particular integrally or monolithically with the machine connection part body 1130. A sleeve inner wall 1141 forms a second sealing surface. The tube 1113 and/or the sleeve 1140 may have chamfered edges 11132, 1142 to facilitate interaction with the vessel unit 2000.

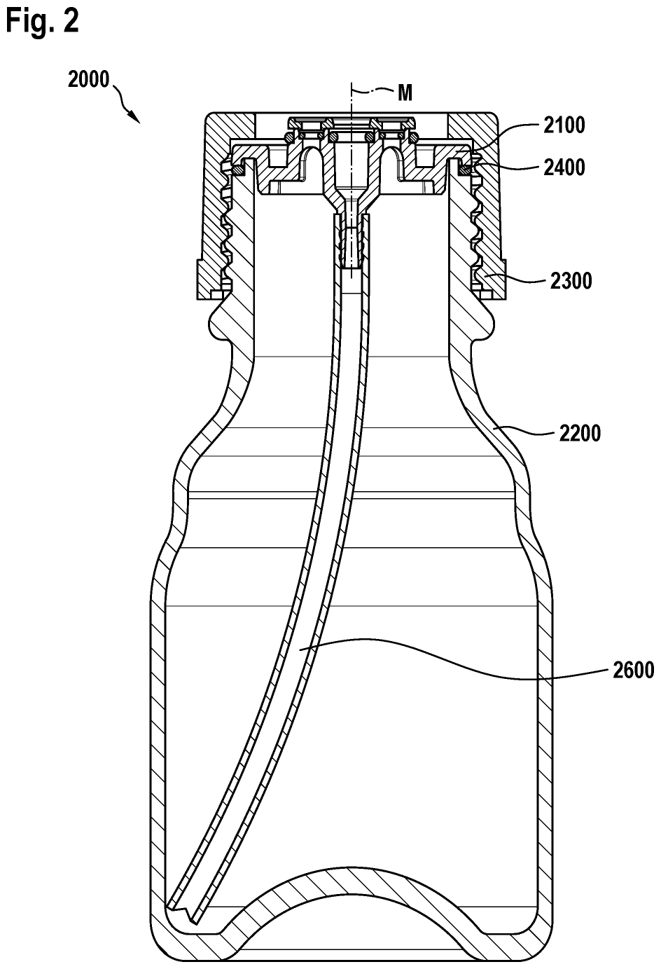

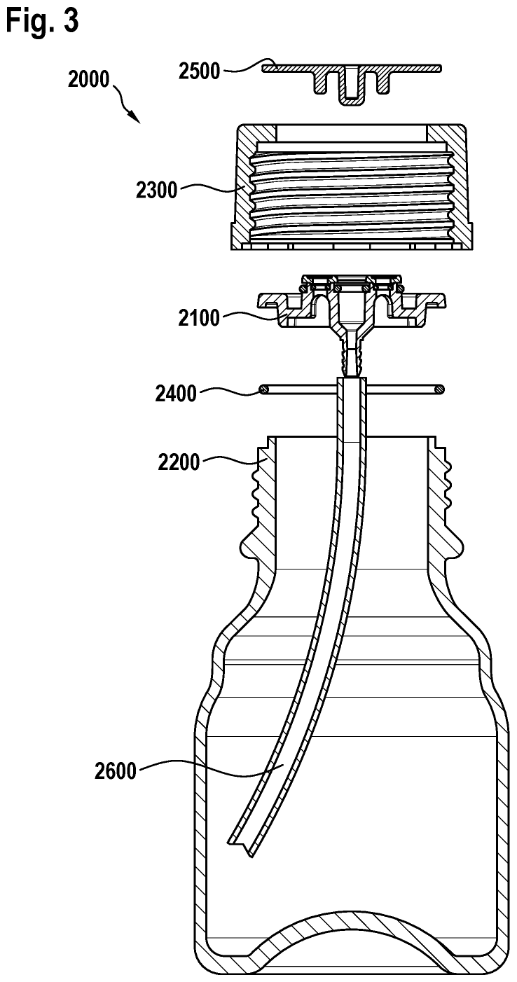

As shown in FIGS. 2 and 3, the vessel unit 2000 here has a bottle-shaped vessel 2200, for example made of plastic or glass, the vessel connection part 2100, in particular made of plastic, and a vessel closure 2300, in particular made of plastic. The vessel closure 2300 may be configured as a screw closure for screwing onto the vessel 2200. A vessel seal 2400, for example in the form of an O-ring, may be provided between the vessel connection part 2100 and the vessel 2200. A vessel cover 2500, in particular also made of plastic, can be arranged on the vessel closure 2300 in order to cover openings in the vessel connection part 2100.

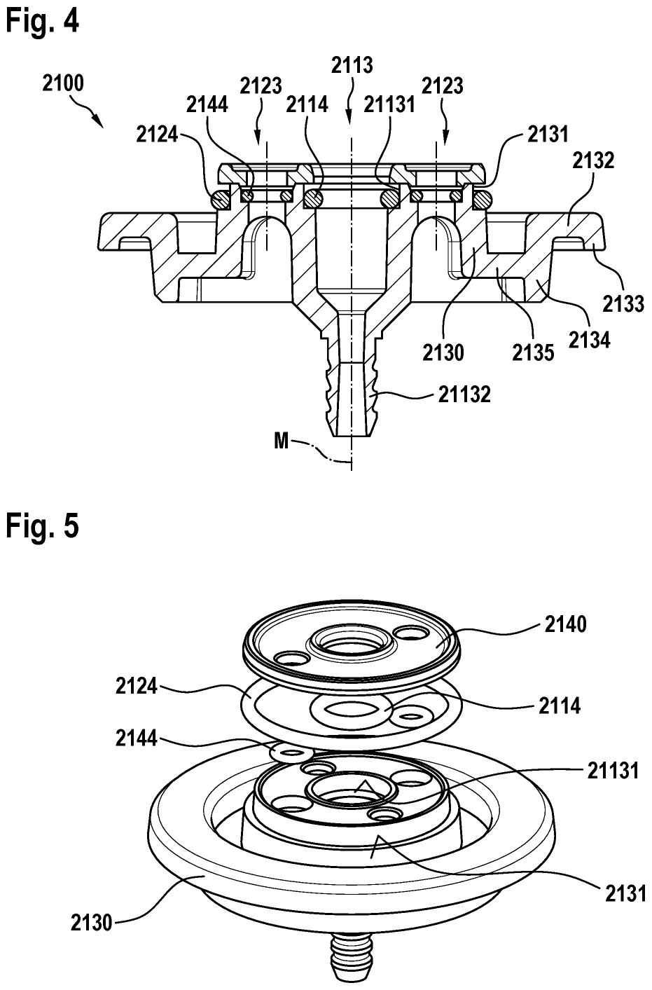

As shown in FIGS. 4 and 5, the vessel connection part 2100 has a vessel connection part body 2130 that has a mounting medium feedthrough 2113 with a third sealing surface formed by a mounting medium feedthrough inner wall 21131. A socket 21132 is disposed on the underside of the mounting medium channel 2113, and a mounting medium hose 2600 extends from the socket 21132 to the bottom of the vessel 2200.

The mounting medium feedthrough 2113 is used to receive the tube 1113 or is configured to receive the tube 1113. The third sealing surface formed by the mounting medium feedthrough inner wall 21131 and the first sealing surface formed by the tube outer wall 11131 are opposite each other when the machine connection part 1100 and the vessel connection part 2100 are connected. The machine mounting medium channel 1110 and the vessel mounting medium channel 2110 are fluid-tightly connected by fluid-tightly connecting the first and third sealing surfaces. For this purpose, a mounting medium seal 2114 in the form of an O-ring may be provided between the first and third sealing surfaces. The mounting medium seal 2114 is attached to or arranged on the vessel connection part body 2130, there in particular in a groove in the mounting medium channel 2113 having the mounting medium feedthrough inner wall 21131.

The vessel connection part body 2130 further comprises, in the present embodiment, two pressure medium feedthroughs 2123, a vessel connection part body outer wall 2131, and a fourth sealing surface formed by the vessel connection part body outer wall 2131. The machine pressure medium channel 1120 and the vessel pressure medium channel 2120 are fluidly connected by fluidly connecting the second and fourth sealing surfaces. For this purpose, a pressure medium seal 2124 in the form of an O-ring may be provided between the second and fourth sealing surfaces. The pressure medium seal 2124 is attached to or arranged on the vessel connection part body 2130, there in particular in a groove comprising the vessel connection part body outer wall 2131.

In order to simplify the production of both the groove in the mounting medium feedthrough 21131, which has the mounting medium feedthrough inner wall 21131, and the groove in the vessel connection part body 2131, which has the vessel connection part outer wall 2131, the vessel connection part body 2130 is connected to a vessel connection part lid 2140, with a groove flank (here the upper side) of each of the two grooves being formed by the vessel connection part lid 2140. In order to ensure tightness of the pressure medium feedthroughs 2123 at the seam or interface between the vessel connection part body 2130 and the vessel connection part lid 2140, a further pressure medium seal 2144 is provided there for each pressure medium feedthrough 2123. Thus, the vessel connection part 2100 is multi-part and comprises, in particular, two injection molded parts and a number of seals.

Advantageously, all seals 2114, 2124, 2144 are arranged on the wearing part, i.e. on the vessel unit 2000 or on the vessel connection part 2100, so that they can be renewed very easily together with the vessel unit 2000 or the vessel connection part 2100. Corresponding maintenance activities on the automatic coverslipper 1000 are not necessary.

The openings of the vessel mounting medium channel 2110 and the vessel pressure medium channel 2120, or specifically here the openings of the mounting medium feedthrough 2113 and the two openings of the pressure medium feedthroughs 2123, are arranged concentrically to a center axis M of the vessel unit 2000, so that the vessel unit 2000 can be connected to the coverslipper in any rotational position about the center axis M. Instead of two pressure medium feedthroughs 2123 here, more than two or only one pressure medium feedthrough 2123, which surrounds the mounting medium feedthrough 2113 in an annular manner, for example, can also be provided, which are nevertheless all arranged concentrically.

In the present case, the vessel connection part 2100 further comprises an external flange 2132 having a shoulder 2133, a cylinder wall 2134 internally adjoining the flange 2132, and an internally adjoining annular portion 2135 which adjoins the vessel connection part body 2130. The flange 2132, shoulder 2133, and cylinder wall 2134 form a contact surface for the vessel seal 2400.

In use, the user may position a vessel unit 2000 filled with mounting medium at a designated location on or within the automatic coverslipper 1000. For example, the coverslipper may include positioning means, such as stops, indentations, etc., to correctly align the vessel unit 2000 with the machine connection part 1100. This may be particularly useful for rough positioning.

Subsequently, the user causes machine connection part 1100, which is arranged in the automatic coverslipper according to the embodiment in a vertically linearly guided manner, to move downward, e.g. manually or automatically. When the automatic coverslipper connection part 1100 is brought into connection with the vessel connection part 2100, the tube 1113, for example, is immersed in the mounting medium channel 2113, whereby the first sealing surface formed by the tube outer wall 11131 and the third sealing surface formed by the mounting medium feedthrough inner wall 21131 are sealed by the mounting medium seal 2114.

Next, the sleeve 1140 of the machine connection part 1100 engages around the vessel connection part body 2130, with the second sealing surface formed by the sleeve inner wall 1141 and the fourth sealing surface formed by the vessel connection part body outer wall 2131 being sealed by the pressure medium seal 2124.

The immersion of the tube 1113 into the mounting medium channel 2113 and the engagement of the sleeve 1140 around the vessel connection part body outer wall 2131 is facilitated or supported in each case by chamfered edges 11132 and 1142, respectively. This can serve in particular for fine positioning.

In the closed position, the sleeve 1140 rests on the vessel connection part or, in this case, on its annular portion 2135.

During operation, pressurized medium, such as compressed air, is forced through the automatic coverslipper pressure medium channel 1120 into an interstitial space 3000 and from there through the vessel pressure medium channel 2120 or the pressure medium feedthroughs 2123 forming it into the vessel 2200. The incoming pressurized medium causes mounting medium to be forced through the mounting medium hose 2600 into the mounting medium feedthrough 2113, the tube 1113 and into the automatic coverslipper.

Once the pressurized medium in the vessel unit 2000 has been used up, the vessel unit 2000 can be separated from the automatic coverslipper again. First, the second and fourth sealing surfaces are disconnected from each other so that the pressure medium in the vessel can escape, as illustrated in FIG. 6. This causes the valve 1114 to close, and only then the first and third sealing surfaces are disconnected from each other. Due to the chronological sequence of the disconnection or separation of the pressure medium channel before the mounting medium channel, an undesired and uncontrolled leakage of the mounting medium can be advantageously avoided during the disconnection or separation of the machine connection part and the vessel connection part.

### LIST OF REFERENCE SIGNS

1 arrangement
10 slide
20, 20′ slide holder
100 transport mechanism
110 body
120 transport jaws
200 coverslipping mechanism
210 receiving location
220 nozzle
221 supply line
223 supply line
224 pump
230 coverslip picker
240 coverslip
300 container
400 display
500 Man/machine interface
600 controller
1000 coverslipper
1100 machine connection part
1110 machine mounting medium channel
1112 mounting medium bore
1113 tube
11131 tube outer wall
11132 edge
1114 valve
1120 machine pressure medium channel
1130 machine connection part body
1140 sleeve
1141 sleeve inner wall
2000 vessel unit
2100 vessel connection part
2110 vessel mounting medium channel
2113 mounting medium feedthrough
21131 mounting medium feedthrough inner wall
21132 socket
2114 mounting medium seal
2120 vessel pressure medium channel
2123 pressure medium feedthrough
2124 pressure medium seal
2130 vessel connection part body
2131 vessel connection part body outer wall
2132 flange
2133 shoulder
2134 cylinder wall
2135 annular portion
2140 vessel connection part lid
2144 pressure medium seal
2200 vessel
2300 vessel closure
2400 vessel seal
2500 vessel cover
2600 mounting medium hose
3000 space
R, X, Y, Z direction
A rotation axis
D distance

What is claimed is:

1. A vessel unit for mounting medium, comprising
a vessel,
a vessel connection part and
a vessel closure,
wherein the vessel connection part is connected to the vessel by the vessel closure,
wherein the vessel connection part comprises a vessel connection part body, a vessel mounting medium channel for the mounting medium, and a vessel pressure medium channel for a pressurized medium,
wherein the vessel unit is adapted to dispense mounting medium via the vessel mounting medium channel when pressurized medium is supplied via the vessel pressure medium channel.

2. The vessel unit according to claim 1, wherein the vessel mounting medium channel includes a mounting medium feedthrough provided in the vessel connection part body and having a third sealing surface formed by a mounting medium feedthrough inner wall.

3. The vessel unit according to claim 2, wherein a socket is arranged at the mounting medium feedthrough, at which socket a mounting medium hose is arranged.

4. The vessel unit according to claim 2, wherein the mounting medium feedthrough is configured to receive a tube, wherein the third sealing surface formed by the mounting medium feedthrough inner wall and a first sealing surface formed by a tube outer wall are opposite each other when the tube is received in the mounting medium feedthrough.

5. The vessel unit according to claim 4, wherein a mounting medium seal, in particular in the form of an O-ring, is provided between the first and third sealing surfaces.

6. The vessel unit according to claim 5, wherein the mounting medium seal is disposed on the vessel connection part body in a groove comprising the mounting medium feedthrough inner wall.

7. The vessel unit according to claim 6, wherein the vessel connection part body is connected to a vessel connection part lid, wherein a groove flank of the groove comprising the mounting medium feedthrough inner wall is formed by the vessel connection part lid.

8. The vessel unit according to claim 1, wherein the vessel pressure medium channel includes at least one pressure medium feedthrough provided in the vessel connection part body.

9. The vessel unit according to claim 8, wherein the vessel connection part body includes a vessel connection part body outer wall, wherein the vessel pressure medium channel includes a fourth sealing surface formed by the vessel connection part body outer wall.

10. The vessel unit according to claim 9, wherein the vessel connection part body is configured to be enclosed by a sleeve having a second sealing surface formed by a sleeve inner wall, the second and fourth sealing surfaces being opposite each other when the vessel connection part body is enclosed by the sleeve.

11. The vessel unit according to claim 10, wherein a pressure medium seal, particularly in the form of an O-ring, is provided between the second and fourth sealing surfaces.

12. The vessel unit according to claim 11, wherein the pressure medium seal is disposed on the vessel connection part body in a groove comprising the vessel connection part body outer wall.

13. The vessel unit according to claim 12, wherein the vessel connection part body is connected to a vessel connection part lid, wherein a groove flank of the groove comprising the vessel connection part body outer wall is formed by the vessel connection part lid.

14. The vessel unit according to claim 13, wherein the at least one pressure medium feedthrough provided in the vessel connection part body has a further pressure medium seal, in particular in the form of an O-ring, at an interface between the vessel connection part body and the vessel connection part lid.

15. The vessel unit according to claim 8, wherein the vessel mounting medium channel includes a mounting medium feedthrough provided in the vessel connection part body, wherein an opening of the mounting medium feedthrough and an opening of the at least one pressure medium feedthrough are arranged concentrically with respect to a central axis of the vessel unit.

16. The vessel unit according to claim 1, wherein an opening of the vessel mounting medium channel and an opening of the vessel pressure medium channel are arranged concentrically with respect to a central axis of the vessel unit.

17. The vessel unit according to claim 1, wherein a vessel seal, in particular in the form of an O-ring, is provided between the vessel connection part and the vessel.

18. The vessel unit according to claim 1, wherein the vessel closure is configured as a screw closure for screwing onto the vessel.

19. The vessel unit according to claim 1, wherein a vessel cover is disposed on the vessel unit closure to cover the vessel mounting medium channel and the vessel pressure medium channel.

20. The vessel unit according to claim 1, wherein the vessel of the vessel unit contains mounting medium.

21. The vessel unit according to claim 1, wherein the vessel of the vessel unit contains solvent.

22. An arrangement comprising
the vessel unit for the mounting medium according to claim 1, and
an automatic coverslipper for automatically applying the mounting medium from the vessel unit and a coverslip to a slide,
wherein the automatic coverslipper has a machine connection part,
wherein the machine connection part comprises a machine connection part body, a machine mounting medium channel for the mounting medium, and a machine pressure medium channel for the pressurized medium,
wherein the machine connection part and the vessel connection part are configured to fluid-tightly connect, on the one hand, the machine mounting medium channel and the vessel mounting medium channel and, on the other hand, the machine pressure medium channel and the vessel pressure medium channel, respectively, when the machine connection part and the vessel connection part are connected, wherein the arrangement is adapted to
connect the machine connection part and the vessel connection part by moving the machine connection part and the connection part relatively to each other in a first direction, wherein first the machine mounting medium channel and the vessel mounting medium channel are fluid-tightly connected and subsequently the machine pressure medium channel and the vessel pressure medium channel are fluid-tightly connected, and
disconnect the machine connection part and the vessel connection part from each other by moving the machine connection part and the connection part relatively to each other in a second direction opposite to the first direction, wherein the fluid-tight connection between the machine pressure medium channel and the vessel pressure medium channel is first disconnected and then the fluid-tight connection between the machine mounting medium channel and the vessel mounting medium channel is disconnected.
